(19) United States
(12) Patent Application Publication
(10) Pub. No.: US 2012/0209715 A1
(43) Pub. Date: Aug. 16, 2012

(54) INTERACTION WITH NETWORKED SCREEN CONTENT VIA MOTION SENSING DEVICE IN RETAIL SETTING

(75) Inventors: Gilad Lotan, Cambridge, MA (US); George Moromisato, Seattle, WA (US); Paresh Suthar, Austin, TX (US); Florin Gale, Kirkland, WA (US); Lili Cheng, Bellevue, WA (US); Jack Ozzie, North Bend, WA (US)

(73) Assignee: MICROSOFT CORPORATION, Redmond, WA (US)

(21) Appl. No.: 13/025,180

(22) Filed: Feb. 11, 2011

(51) Int. Cl. G06Q 30/00; G06F 3/01

(52) U.S. Cl. 705/14.58; 345/156; 705/14.49; 705/14.66

(57) ABSTRACT

A computing device may be configured to allow a shopper to interact with one or more displays in a retail environment. A perception device may detect human actions in the retail environment and the shopper may be able to use human movements to navigate through retail data and have it displayed on the display device in the retail environment.

### BACKGROUND

In a retail environment, trying to gain attention of shoppers is more and more challenging. Traditional displays may be ignored or may have little effect as shoppers assume there is nothing new on the display device. In addition, the content displayed does not change frequently, causing shoppers to be bored with the displays.

Electronic advertisements may be more eye-catching that traditional static displays. However, even electronic displays that change over time can lose their effectiveness as shoppers become familiar with the content. Further, the lack of interaction with the display device means a retailer decides what is displayed to a shopper, rather than allowing the shopper to decide.

In addition, shoppers are accustomed to being in control of electronic displays, both on portable devices and on larger displays. The attention span of shoppers continues to drop and traditional methods of pushing advertisements to shoppers have less and less effect. Further, most advertisements are not additional, un-seen information, but old information repackaged. Finally, the shopper does not have the ability to manipulate a display device toward specific information desired by the shopper.

### SUMMARY

By allowing a shopper to control a display device in a retail environment using human motion, additional interest in the retail environment may be generated. A perception device may perceive human movement and the human movement may be translated into commands by a computing device to control the display devices in the retail environment. An indication may be received that an application is available to interaction with the display device in the retail environment. In addition, the device may recognize items that consumers place near the perception device and display information related to the items.

Human actions perceived by the perception device may be communicated to the display device in the retail environment to move an indication on the display device in the retail environment related to the inputs on the mobile communication device. The indication on the display device in the retail environment may be maneuvered over selectable areas and using human motion, items may be selected on the display device. A second may be displayed on the display device in response to the selected item wherein the second image may include additional retail related data and at least one selectable area.

### DESCRIPTION OF THE FIGURES

FIG. 1 illustrates a sample computing device that may be physically configured according to computer executable instructions;

FIG. 2 illustrates steps that are executed by the physically configured portable computing device;

FIG. 3 illustrates a retail environment with a computing device, a portable computing device and a display;

FIG. 4a illustrates an image of a shopper making movements that may be perceived by the perception device;

FIG. 4b illustrates a display device in the retail environment;

FIG. 5a illustrates an image of a shopper making movements that are perceived by the perception device; and

FIG. 5b illustrates a second image on the display device in the retail environment.

### SPECIFICATION

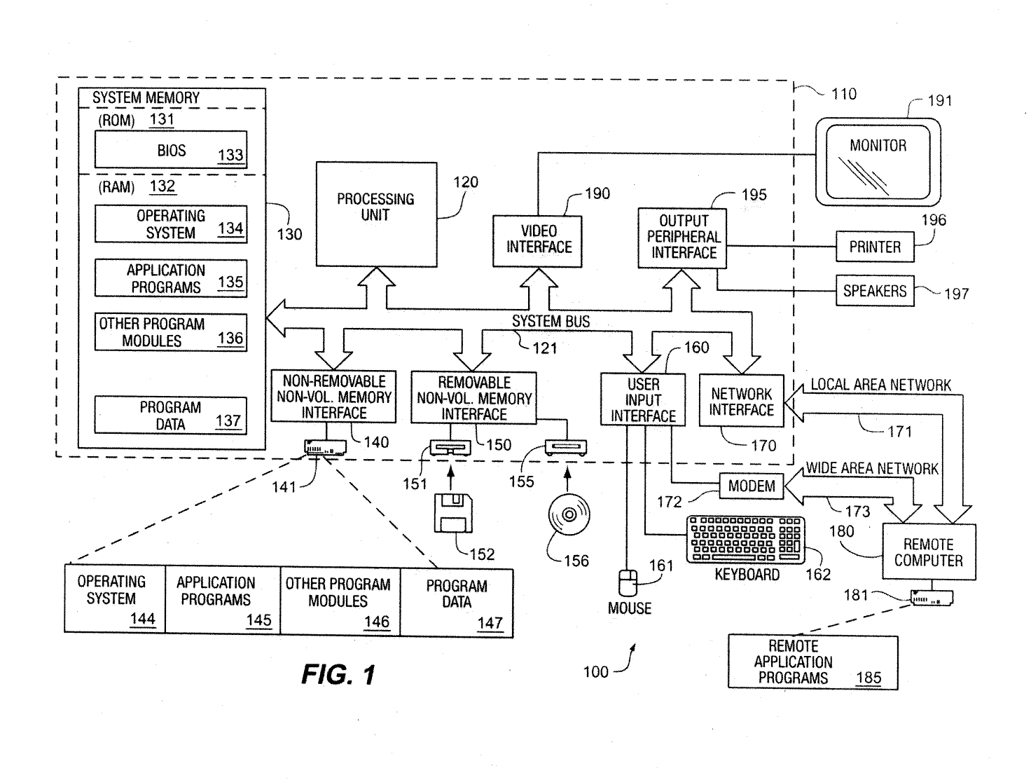

FIG. 1 illustrates an example of a suitable computing system environment 100 that may be physically configured to operate, display device and provide a shopper interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100. In one embodiment, the device described in the specification is entirely created out of hardware as a dedicated unit that is physically transformed according to the description of the specification and claims. In other embodiments, the device executes software and yet additional embodiment, the device is a combination of hardware that is physically transformed and software.

With reference to FIG. 1, an exemplary system that may be physically configured for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170. In addition, not all the physical components need to be located at the same place. In some embodiments, the processing unit 120 may be part of a cloud of processing units 120 or computers 110 that may be accessed through a network.

Computer 110 typically includes a variety of computer readable media that may be any available media that may be accessed by computer 110 and includes both volatile and nonvolatile media, removable and non-removable media. The system memory 130 may include computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150. However, none of the memory devices such as the computer storage media are intended to cover transitory signals or carrier waves.

A shopper may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a shopper input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

In additional embodiments, the processing unit 120 may be separated into numerous separate elements that may be shut down individually to conserve power. The separate elements may be related to specific functions. For example, an electronic communication function that controls Wi-Fi, Bluetooth, etc, may be a separate physical element that may be turned off to conserve power when electronic communication is not necessary. Each physical elements may be physically configured according to the specification and claims described herein.

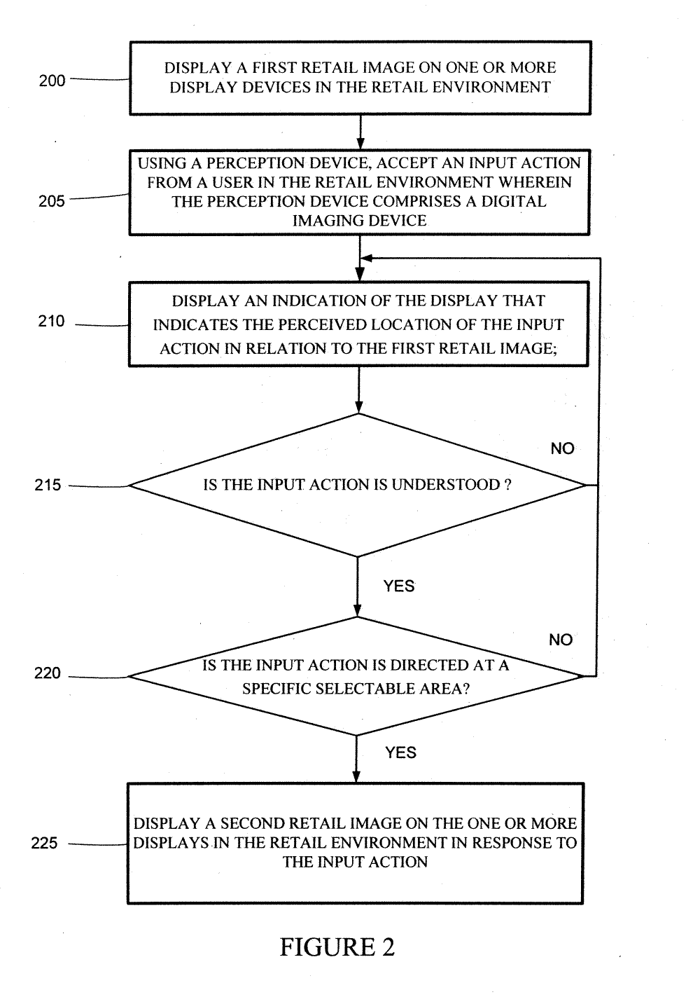

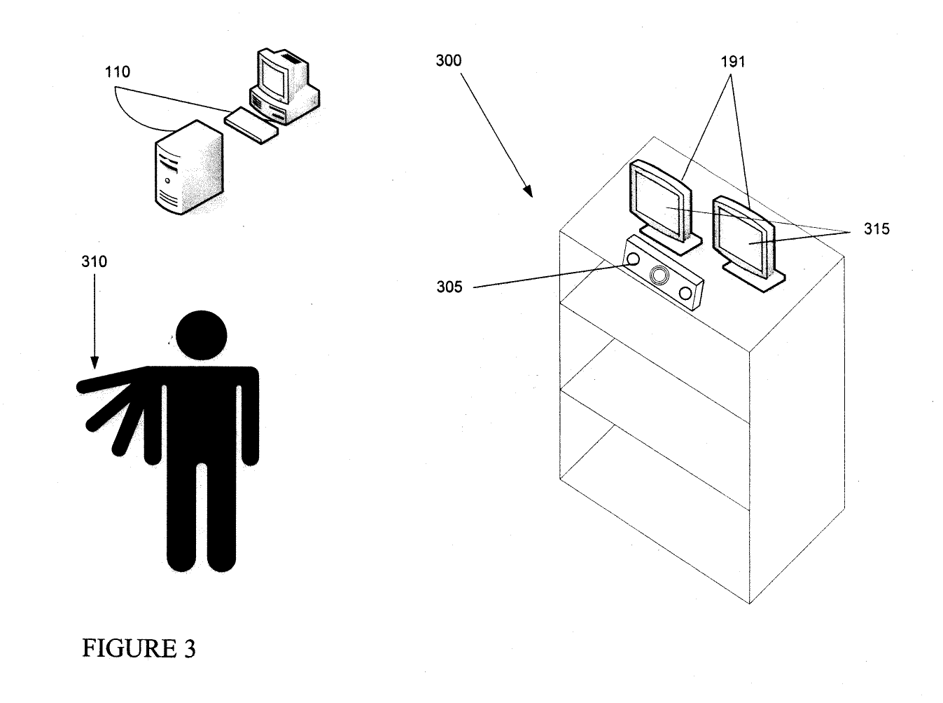

FIG. 2 illustrates a method of controlling a computing device 110 to control one or more display devices in a retail environment 300. The method may be implemented on a purpose built device such a computer 110 that is transformed to execute the method or may be in software that physically configures a computing device 110 to execute the method or variations of the method. At block 200, a first retail image 315 may be displayed on one or more display devices 191 in the retail environment. The first retail image may include retail related data and at least one selectable area.

The display device 191 in the retail environment 300 may illustrate retail related data and the at least one selectable area or item 430. The retail environment 300 may be a physical location that sells goods or services or a combination thereof. The retail environment 300 may have one or more displays 191 such as an LCD display, plasma display, OLED display, a projector of any type and a display device area or CRT display device 191. The type of the display device 191 may be store dependant as some retail environments may have space constraints that may drive the display device 191 selection.

In addition, the retail environment 300 may have a computer 110 such as a computer 110 described in FIG. 1. The computer 110 may be configured to handle and serve the video images for the display, communicate with a mobile communication device and store the data, such as catalog data or sale data, to be displayed as images 315 on the display device 191. The computer 110 may be a single computer configured to handle all the necessary tasks or could be part of a networked system that separates the various tasks over a plurality of computers 110 and processing units 120, including processing units that operate remotely in a cloud.

In one embodiment, a ribbon is on one of more side of first retail image 315 on the display device 191 that displays store retailed data in a crawling manner. In another embodiment, the crawling data in the ribbon is specific to the shopper. In yet another embodiment, the crawling data is related to the item or items that are currently on the display device 191. The display device 191 may be in communication with the computing device 110 through traditional wired methods or through wireless methods.

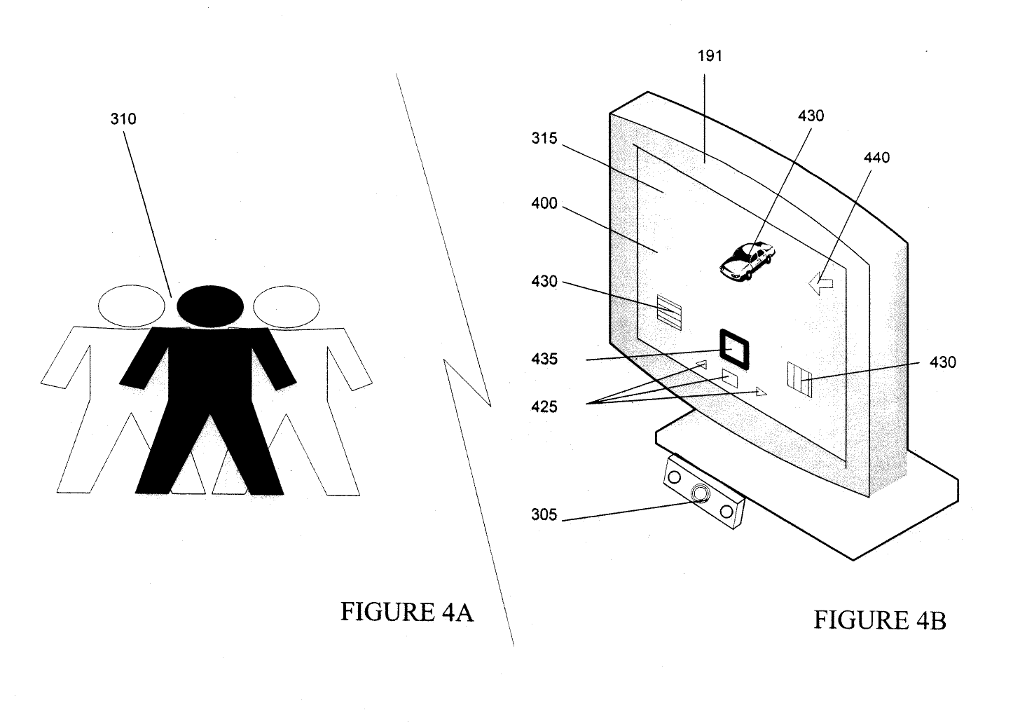

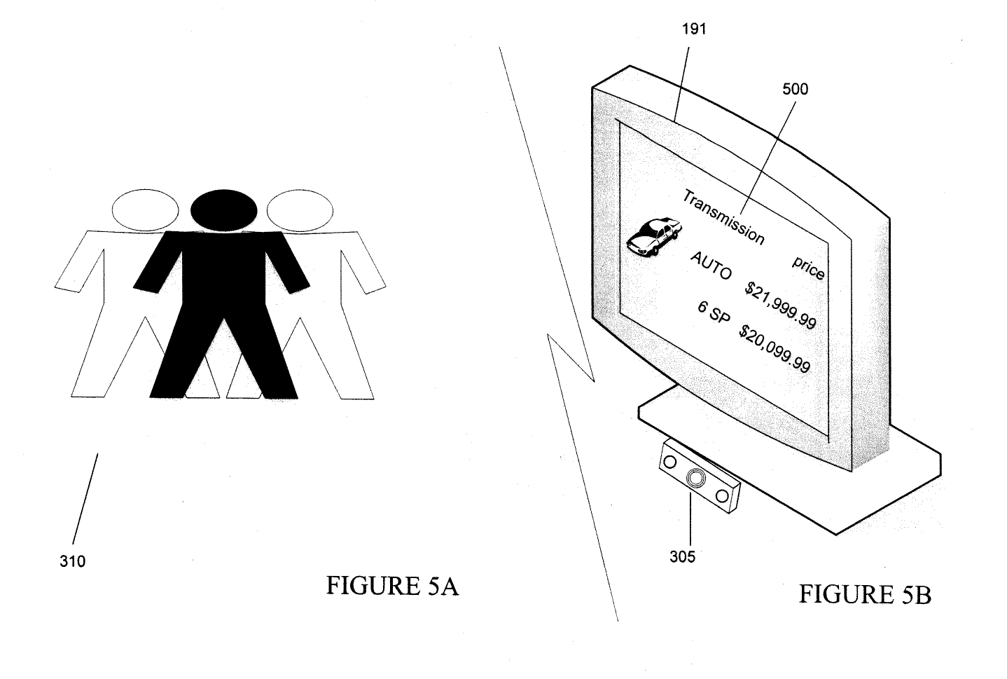

In some embodiments, there are multiple displays 191 in the retail environment 300. The displays 191 may be next to each other, may be stacked on top of each other, may form a perimeter around the retail environment 300 or the displays 191 may be in various combinations. The computer 110 may be configured to manipulate the display device image 315 in a variety of ways to creating interesting display device images 315 over the plurality of displays 191. In one embodiment, the image 315 is split over the plurality of displays to make a single, unified image 315. In another embodiment, the image 315 scrolls from one display device 191 to another. In other embodiments, a primary image 315 is displayed on a first monitor and a second image with additional detail is displayed on a second display device 191. Of course, these are simply examples and not limitations and the concepts can be combined and mixed in a variety of applicable ways. In other embodiments, as previously mentioned, the computer 110, may be in a cloud (such as a group of remote servers accessible through a network) and may be accessed from the retail environment through a network to control the display device 191. In addition, the displayed images may be a first display image 400 (FIG. 4) or a second display image 500 (FIG. 5).

The retail related data may include information about products or services that are available at the retail environment 300. The retail related data may be in the form of a catalog or may be in a form created to take advantage of the size and placement of the display device 191. For example, if there are several display devices 191 next to each other, a wider display may be in order. In another approach, the display device 191 may be able to display moving pictures such as WAV or MPEG files for example and not limitation and such movies may be the retail related data.

Referring to FIG. 4B, the selectable areas 425, 430, 435 may be navigational areas 425. By selecting the navigational items 425, the first display image 400 or second display image 500 (FIG. 5B) may be changed to move forward a page, move back a page, slide the page over or slide an item up/down. If the retail related data is a movie, the movie may be fast forwarded, rewound, pause, etc. Of course, the navigation areas 425 may be given additional or application specific tasks based on the application and the designs of the application designer.

The selectable area 430 may also be items on the display image 315 that can be selected to provide more information about the selected item 430. Items that may be selected may be indicated by flashing, being highlighted 435 or being displayed in three dimensions. Of course other manners of indicating that an item is selectable are possible and are contemplated. The selectable 430 areas or items may be highlighted 435 on the display device image 315 when the shopper moves a pointer or makes a selection action over the selectable areas 430. The highlighting may indicate that additional information is available or that a sale is occurring, for example. The highlighting 435 may indicate the type of event that is occurring. As an example and not a limitation, red highlighting 435 may indicate a close-out sale whereas blue highlighting 435 may indicate a new item. Of course, additional methods of using highlighting 435 to gain attention are possible and are contemplated.

In some embodiments, the computer 110 may be configured to determine if the shopper is a known shopper. If the shopper is a known shopper, the display image 315 may contain an image tailored to the known shopper. The determination may be made in several ways. In some examples, the electronic signals may be received from a mobile computing device such as a cellular telephone or WiFi enabled portable computing device and the electronic signals may be analyzed to determine if the electronic signals are recognized as belonging to a known shopper. The electronic signals may be an identification signal of the mobile computing device, for example. In another embodiment, the mobile computing device shopper may be asked to enter identification information and this information may be reviewed to determine if the identification information is recognized. Similar procedures may be followed if the communication may be through Bluetooth, through the cellular network or through any other appropriate communication method.

In other embodiments, facial recognition may be used to determine if a shopper is known. A perception device 305 may include one or more electronic cameras and it may have one or more microphones. The electronic camera may take one or more images and compare the images to known images. If the image is recognized or is sufficiently close to a known or stored image, the computer 110 may proceed under the assumption that the shopper is the known person. In some embodiments, the image may be of a face of a shopper but in other embodiments, additional detail may be used to identify a shopper including height, width, arm length, shoe size, etc. If two or more cameras are used, additional dimensional detail may be obtained and used to recognize the shopper. In some additional embodiments, the shopper may be presented the option to select whether a known shopper is the shopper and the shopper can select whether to be recognized and possibly receive personalized content.

In yet another embodiment, a voice of the shopper may be received by the perception device 305, stored in a memory and analyzed. If the voice is sufficiently similar to a stored voice of a known shopper, the computer 110 may assume the known shopper is near the display 191. In some additional embodiments, the shopper may be presented the option to select whether a known shopper is the shopper and the shopper can select whether to be recognized and possibly receive personalized content. Of course, all manners of determining whether a shopper is known may work together, in whole or in part, to further increase the ability to accurately assess whether a shopper is known. For example, a voice may be close to a known shopper but if the known shopper is 6 feet tall and the present shopper is less than 5 feet tall, then the likelihood that the shopper is known may be less.

If the shopper is known, the first image 400 may be of tailored content. The tailored content may be determined in several ways. In one embodiment, past purchases of the shopper may be analyzed to determine if any complementary items are available for sale and the complementary purchases may be displayed as the first image 400. In another embodiment, if the known shopper has used a store web site, the items viewed on the web site may be displayed. In yet another embodiment, if the shopper normally buys sale items, items on sale may be displayed. Of course, the determination of tailored content may take on many forms, all of which are contemplated.

If the shopper is not known, the computer 110 may collect and store data about the shopper so that in the future, the shopper will be recognized. In some embodiments, the shopper is given the option whether to have the information stored.

At block 205, a perception device 305 may be used to accept an input action from a shopper in the retail environment 300. The perception device 305 may include one or more digital imaging devices such as a digital camera. In some embodiments, the perception device 305 may also include a microphone which may also be used to receive and analyze voices. In other embodiments, the perception device 305 may include an infrared sensor which may be used to assist in detecting additional information about a shopper. The perception device 305 may perceive specific personal characteristics through a camera, a microphone, other electronic signals or a combination of data.

The perception device 305 may communicate perception data to the computer 110 through wired communication or through wireless communication such as WiFi or Bluetooth. In some embodiments, the perception device 305 may communicate raw data, in other embodiments, the perception device 305 may format the data before communicating it and in additional embodiments, the perception device 305 may perform some analysis on the data before it is communicated. Of course, the data that is communicated is related to the perception device 305 itself, more specifically, if the perception device has a camera, the data communication will be related to the images received by the camera, etc.

The input action 310 may be movements of the shopper that may be received by the perception device 305. The perception device 305 may perceive movements and actions of the shopper and use the computer 110 to translate the movements and action of the shopper into actions of the display device 191. Some sample actions or movements may be speaking, walking through the retail environment 300, kicking in the retail environment 300, swiping in the retail environment 300, grabbing in the retail environment 300, sitting in the retail environment 300, etc. The input actions 310 may also related to the image 315 being displayed. For example, if the image 315 being displayed is a movie, swiping actions by a shopper may fast forward or review the movie. Similarly, if the image 315 is of a catalog, the swiping action of a shopper may flip pages of a catalog, where a faster swipe may flip numerous pages and a slower swipe may flip fewer pages. Feet can just as easily be used to control the image 315 being displayed as well as an entire body movement such as walking or falling. Of course, other input actions 310 are possible and are contemplated.

In some embodiments, more than one perception devices 305 may be used. As a result, a shopper can move over an even larger area and make even more exaggerated movements which may but understood by the computer 110. In addition, if the perception devices 305 are aimed at a similar point but from different angles, a three dimensional image of a shopper may be created by evaluating the data from multiple perception devices 305 looking at the same shopper from a plurality of angles.

At block 210, an indication 440 may be displayed as part of the image 315 on the display device 191 that indicates the perceived location of the input action 310 in relation to the first retail image 400. The indication 440 on the display device 191 may be a type of a pointer such as an arrow that is moved by a mouse on modern computer systems 110. In other embodiments, the indication may simply move from one item on the display device 191 to another item in the display device 191. In yet another embodiment, the indication 440 may be related to the type of store. As an example and not a limitation, the indication in a car dealer may be a car that moves in response to movements made 310 by a consumer. The input action 310 may be any inputs made near the perception device 305 or by using directional controls in the image 315 on display device 191. In other embodiments, a pointer or a finger may be used on a touch sensitive display device 191 to direct or assist the indication 440.

The perceived location of the indication 440 may be manipulated by moving the indication 440 from its original starting point to a new point. The manipulation may occur by the shopper making movements near the perception device 305 that are translated into movements of the indication 440. Logically, if the indication 440 is on the left side of the image 315 and the shopper swipes his arm toward a selectable area 430 on the right side of the display image 315, the indication 440 will move toward the right side of the display image 315, in some embodiments, toward the selectable area 430 that is closest to the projected movement of the indication 440.

The perceived location may take into account direction and speed of the movement of the shopper. For example, a fast, long arm swing as the input action 310 by a shopper may turn several pages of a catalog image being displayed on the display device 191. A slower, grabbing motion by a hand as the input action 310 of the shopper may select a selectable item 430. A slashing motion as the input action 310 by a shopper may remove an item from the display image.

The first retail image 400 (FIG. 4) may be determined in a variety of ways. In one embodiment, there may be a rotation of first images 400 that are designed to attract attention of shoppers. The processor 120 may also be configured to determine a location of the shopper in the retail environment 300 using location signals in the mobile communication device and displaying images 400 that relate to the location of the shopper in the retail environment. For example, if the shopper is near jeans, the display device 191 may display device images 315 related to a sale on jeans as the first image 400. In additional embodiments, the location of the shopper may be received by using RFID signals from goods in the store that a shopper has selected. One of the perception devices 305 may also be used to assist verifying a location of a shopper in the retail environment 300.

At block 215, the processor 120 may determine whether the input action 310 is understood. In one embodiment, the method or processor 120 configured according to the method may determine if the input action 310 is sufficiently similar to a known action. Simply walking by the perception device 305 may result in an attempt to determine if the shopper walking was trying to interact with the first image 400, for example. In fact, walking by the perception device 305 may cause the display 191 to display an image 315 to let the shopper know that the display is interactive and can be used by the shopper. However, differentiating between a shopper walking by and a shopper that is attempting to interact with the display 191 can be a challenge.

In one embodiment, the actions 310 of the shopper are compared to known actions that are understood. For example, the processor may be configured to recognize horizontal arm swings (rather than walking arm swings) as being attempt to create an input action 310. The actions 310 may be specific to the images currently being displayed. For example, if the display is of a catalog, the recognized actions may be actions related to manipulating the catalog, such as turning a few pages, turning lots of pages, selecting an item in the catalog, pivoting an item in the catalog, changing colors of the items, etc. All of the actions to the image in the display may be compared to stored known actions (which may or may not be application specific) and if the action is understood or is sufficiently similar to a stored known action, the related action may occur.

At block 220, if the input action 310 is understood, the processor 120 may be configured to determine if the input action 310 is directed at a specific selectable area 430. As mentioned previously, the selectable areas 425, 430, 435 may be navigational areas 425. By selecting the navigational item 425, the display image 315 may be changed to move forward a page, move back a page, slide the page over or slide an item up/down. If the retail related data is a movie, the movie may be fast forwarded, rewound, pause, etc. Of course, the navigation areas 425 may be given additional or application specific tasks based on the application and the designs of the application designer. The selectable area 430 may also be items on the display image 315 that can be selected to provide more information about the selected item 430. The selectable 430 areas or items may be highlighted 435 on the display device image 315 when the shopper moves a pointer or makes a selection action over the selectable areas 430. The highlighting may indicate that additional information is available or that a sale is occurring, for example. The highlighting 435 may indicate the type of event that is occurring. As an example and not a limitation, red highlighting 435 may indicate a close-out sale whereas blue highlighting 435 may indicate a new item. Of course, additional methods of using highlighting 435 to gain attention are possible and are contemplated.

At block 225, if the input action is directed toward the specific selectable area such as highlighted area 435, a second retail image 500 (FIG. 5) may be displayed on the one or more displays 191 in the retail environment 300 in response to the input action 310. The second retail image 500 may include additional retail related data and at least one selectable area 430. As examples and not limitations, the second retail image 500 may include turning a page in a catalog, selecting an item in the first image, displaying additional detail related to the item, displaying the selected item on a shopper, displaying the select item, panning the item, rotating the item and pivoting the item.

In some embodiments, the second image 500 in the retail environment may include additional content that is not available outside the retail environment. As examples and not limitations, the addition content may include additional video, additional sound, additional images, additional text, additional colors, additional goods, additional sale prices, additional catalog pages and additional data regarding purchasing trends.

In some embodiments, the additional content in the second image 500 may be more remotely related to the retail environment 300 but may cause the shopper to interact with the display 191 in more detail. As an example and not limitation, the second image 500 may be a game that is related to the retail environment. The shopper may be able to play and modify the game and possibly win rewards that may be redeemed at the store. The rewards may appear at a sales checkout at the store as a printed document, may be an electronic signal at the cash register, may be emailed to a known shopper, may be transmitted to a mobile computing device of a shopper, etc.

In yet another embodiment, the second image 500 may allow a shopper to manipulate one or more cameras on the perception device 305. The shopper may use the navigational selectable items 425 to move the camera or the shopper may select the camera and then use human movements perceived by the perception device 305 to move the camera or cameras. In a similar concept, a shopper may control the images 315 being displayed, such as being able to zoom in on the images, pan left, pan right, pan up, pan down, etc.

In yet another embodiment, the second display 500 may be an avatar that is related to the shopper that has been perceived by the perception device. If the shopper is a known shopper, the avatar may be an avatar created by the shopper previously, either at the retail environment 300 or at another location. If the shopper is not a known shopper, there may be an option to modify the avatar as desired by the shopper.

In yet another embodiment, the second display 500 may be a reflection of the shopper displayed as a virtual shopper and the virtual shopper may be dressed or displayed in clothes or good from the retail environment 300. The virtual shopper may reflect the size and shape of the shopper as perceived by the perception device. In this way, the shopper can view items an a virtual representation of themselves and can manipulate the virtual representation to view the clothes from a variety of angles. In some embodiments, the processor may be configured to make suggestions as to what clothes would be appropriate for the specific body type of the shopper. In other embodiment, the suggestions may be based on what the shopper is currently wearing, what the shopper has purchased in the past or, if the shopper is known, what the shopper has viewed online recently.

Similarly, if the shopper is looking for wheels for a car, a virtual representation of the car may be selected and the different wheel combinations may be view on the virtual representation of the car as the second image 500. Once the second image 500 is displayed, the processor 120 may be configured to let the process continue with the second image 500 acting as the new first image 400 and if a selectable item 430 is chosen by a shopper, a new second image 500 may be displayed.

At block 230, if the input action 310 is not understood or not directed toward a specific selectable area, the first retail image 400 may be displayed. In some embodiments, a separate display image 315 may be displayed that indicates that the input movement 310 was not understood. In some embodiments, the shopper may be able to assign certain input actions 310 to have certain controlling results of the image 315 on the display device 191. The input actions 310 are not just limited to physical movements but could also include voice inputs.

FIGS. 4A, 4B, 5A and 5B may illustrate a potential scenario in which the processor 120 is configured to implement a method as reflected in the claims. If the retail environment 300 is an auto dealer, a shopper may first select a car from a first image 400 on a display device 191 of a variety of cars. Next, the shopper may make additional selections of selectable items 430 that are specifically related to that car, such as the interior options, interior colors, interior fabrics, etc., which may result in a second display 500. Each of these second displays 500 may have additional content. For example, when a shopper is selecting a wheel combination, a video of the wheel moving on the selected model may be displayed and such a display device may be available only in the retail environment 300.

The processor 120 may also be configured to determine a location of the shopper in the retail environment 300 using location signals from one or more perception devices 305 and displaying images that relate to the location of the shopper in the retail environment 300. For example, if the shopper is near jeans, the display device 191 may display device images 315 related to a sale on jeans. In additional embodiments, the location of the shopper may be received by using RFID signals from goods in the store that a shopper has selected, from GPS signals or from mobile computing devices used by a shopper. Visual sensors may also be used to assist verifying a location of a shopper in the retail environment 300.

In use, there may be times when more than one shopper desires to communicate with the display device 191 in the retail environment 300. In one embodiment, a queue may be created that tracks shoppers that desire to communicate with the display device 191. The queue may be displayed on the display device 191, or may be kept internally in the computing system 110. When a shopper leaves the retail environment, the shopper may be removed from the queue. In another embodiment, known shoppers that are considered profit centers or especially valuable shoppers may be allowed to move ahead in the queue. Of course, other arrangements are possible.

In addition, the device may recognize items that users place near the perception device 305 and display information, either as the first display 400 or second display 500, related to the items. For example, a user may hold up a mobile phone that is for sale and the display 191 may create a first display 400 of information related to that specific mobile phone. In addition, a user may hold up two mobile phones and information about both mobile phones may be displayed on the display 191. In other embodiments, a user may be able to indicate whether a comparison of items, either being held up by a user or in the computer system 110 is desired. Once the information about the item is displayed, a user may again use movement to obtain additional information about the item such as a second display 500 that illustrates the various calling plans for each of the mobile phones in question. Of course, additional embodiments are possible and are contemplated.

In action, a shopper may walk into a retail environment 300 such as a jeans store. The shopper may receive a notification that an application is available to control one or more displays 191 in the store through movements near the perception device 305. In other embodiments, the display device 191 may note that the display device 191 may be controlled by the perception device 305. If the shopper is interested, the first display image 400 may be general information about the jeans that are available or any sale that are occurring. If the computer 110 can determine the location of the shopper in the store such as by GPS, RFID or through one or more perception devices 305, the display device 191 may also display information about the jeans that are in the near vicinity of the shopper. The shopper may then use the perception device 305 to select selectable items 430, such as jeans in stock in a desired size. The movement of the shopper near the perception device 191 may move a selector 440 on the display device 191 and selectable items 430 may be highlighted 435 on the display device 191. The shopper may then select a selectable item 430 using body movements near the perception device 305 and a second display image may be displayed that contains additional information about the selected items 430 may be displayed.

One advantage of the many advantages of the system is that shoppers can now interact with a display device 191 in a store to obtain the information desired. The shoppers will be able to interact and control one or more displays 191 using movement. As a result, the shoppers will be more interested in the display device 191 as the shopper can control the display device 191 to illustrate the information that the shopper most desires.

1. A method of controlling one or more display devices in a retail environment comprising:
Displaying a first retail image on one or more display devices in the retail environment where the first retail image comprises retail related data and at least one selectable area;
Using a perception device, accepting an input action from a shopper in the retail environment wherein the perception device comprises a digital imaging device;
Displaying an indication of the display device that indicates a perceived location of the input action in relation to the first retail image;
Determining whether the input action is understood comprising determining if the input action is sufficiently similar to a known action;
If the input action is understood, determining if the input action is directed at a specific selectable area;
If the input action is directed toward the specific selectable area, displaying a second retail image on the one or more displays in the retail environment in response to the input action wherein the second retail image comprises additional retail related data and at least one selectable area; and
If the input action is not understood or not directed toward a specific selectable area, displaying the first retail image.

2. The method of claim 1, wherein the second retail image comprises an image selected from a group comprising:
Turning a page in a catalog;
Selecting an item in the first retail image;
Displaying additional detail related to the item;
Displaying the selected item on the shopper;
Displaying the selected item;
Panning the item;
Rotating the item; and
Pivoting the item.

3. The method of claim 1, wherein the input action comprises one selected from a group comprising:
Walking through the retail environment;
Kicking in the retail environment;
Swiping in the retail environment;
Grabbing in the retail environment;
Sitting in the retail environment;
Standing in the retail environment.

4. The method of claim 1, wherein the second retail image in the retail environment comprises additional content that is not available outside the retail environment.

5. The method of claim 4, wherein addition content comprises at least one selected from a group comprising:
additional video;
additional sound;
additional images;
additional text;
additional colors;
additional goods;
additional sale prices;
additional catalog pages; and
additional data regarding purchasing trends.

6. The method of claim 1, wherein if there are more than one display devices, coordinating the display devices to display the first retail image or the second retail image in a unified manner.

7. The method of claim 1, further comprising using a plurality of perception devices.

8. The method of claim 1, further comprising:
determining if the shopper is a known shopper,
if the shopper is a known shopper,
determining tailored content for the known shopper and
displaying the tailored content on the display devices.

9. The method of claim 8, wherein determining if the shopper is a known shopper further comprises:
using the perception device to capture facial images, and
analyzing the facial images to determine if the facial images are recognized as being a known shopper.

10. The method of claim 9, wherein determining if the shopper is known further comprises:
receiving electronic signals from the shopper;
analyzing the electronic signals to determine if the electronic signals are recognized as belonging to a known shopper.

11. The method of claim 1, further comprising determining a location of the shopper in the retail environment and displaying images that relate to the location of the shopper in the retail environment.

12. The method of claim 11, wherein determining the location of the shopper further comprises using an image device to determine the location of the shopper.

13. The method of claim 11, wherein determining the location of the shopper further comprises receiving RFID signals from goods in the retail environment that the shopper has selected.

14. A computing device comprising a processor, a memory and an input/output device wherein the processor is configured to execute computer executable instructions, the computer executable instructions comprising instructions for:
Displaying a first retail image on one or more display devices in a retail environment where the first retail image comprises retail related data and at least one selectable area;
Using a perception device, accepting an input action from a shopper in the retail environment wherein the perception device comprises a digital imaging device;
Displaying an indication of the display device that indicates a perceived location of the input action in relation to the first retail image;
Determining whether the input action is understood comprising determining if the input action is sufficiently similar to a known action;
If the input action is understood, determining if the input action is directed at a specific selectable area;
If the input action is directed toward the specific selectable area, displaying a second retail image on the one or more displays in the retail environment in response to the input action wherein the second retail image comprises additional retail related data and at least one selectable area; and
If the input action is not understood or not directed toward a specific selectable area, displaying the first retail image.

15. The computing device of claim 14, wherein the second retail image comprises an image selected from a group comprising:
Turning a page in a catalog;
Selecting an item in the first retail image;
Displaying additional detail related to the item;
Displaying the selected item on the shopper;
Displaying the selected item;
Panning the item;
Rotating the item; and
Pivoting the item.

16. The computing device of claim 14, wherein the input action comprises one selected from a group comprising:
Walking through the retail environment;
Kicking in the retail environment;
Swiping in the retail environment;
Grabbing in the retail environment;

17. The computing device of claim 14, wherein the second retail image in the retail environment comprises additional content and wherein the addition content comprises at least one selected from a group comprising:
additional video;
additional sound;
additional images;
additional text;
additional colors;
additional goods;
additional sale prices;
additional catalog pages; and
additional data regarding purchasing trends.

18. The computing device of claim 14, further comprising:
determining if the shopper is a known shopper comprising
using the perception device to capture shopper specific personal characteristics comprising at least one selected from a group comprising the shopper's voice, the shopper's height, the shopper's width, the shopper's facial features and the shopper's proportions;
analyzing the shopper specific personal characteristics to determine if the specific personal characteristics are recognized as belonging to a known shopper;
if the shopper is a known shopper,
determining tailored content for the known shopper and
displaying the tailored content on the display devices.

19. The computing device of claim 14, further comprising:
determining a location of the shopper in the retail environment and
displaying images that relate to the location of the shopper in the retail environment wherein
determining the location of the shopper further comprises:
using an image device to determine the location of the shopper or
receiving RFID signals from goods in the retail environment that a shopper has selected.

20. A non-transitory computer storage medium physically configured with computer executable instructions, the computer executable instructions comprising instructions for:
Displaying a first retail image on one or more display devices in a retail environment where the first retail image comprises retail related data and at least one selectable area;
Using a perception device, accepting an input action from a shopper in the retail environment wherein the perception device comprises a digital imaging device;
Determining if the shopper is a known shopper comprising
using the perception device to capture shopper specific personal characteristics comprising at least one selected from a group comprising the shopper's voice, the shopper's height, the shopper's width, the shopper's facial features and the shopper's proportions;
analyzing the shopper specific personal characteristics to determine if the specific personal characteristics are recognized as belonging to a known shopper;
if the shopper is a known shopper,
determining tailored content for the known shopper and
displaying the tailored content on the display devices as the first retail image;
Displaying an indication of the display device that indicates a perceived location of the input action in relation to the first retail image;
Determining whether the input action is understood comprising determining if the input action is sufficiently similar to a known action;
If the input action is understood, determining if the input action is directed at a specific selectable area;
If the input action is directed toward the specific selectable area, displaying a second retail image on the one or more displays in the retail environment in response to the input action wherein the second retail image comprises additional retail related data and at least one selectable area; and
If the input action is not understood or not directed toward a specific selectable area, displaying the first retail image.
